(19) United States
(12) Patent Application Publication
(10) Pub. No.: US 2025/0121527 A1
(43) Pub. Date: Apr. 17, 2025

(54) WORKING MACHINE

(71) Applicant: MAKITA CORPORATION, Anjo-shi (JP)

(72) Inventors: Takuma OHASHI, Anjo-shi (JP); Daisuke SUZUKI, Anjo-shi (JP)

(73) Assignee: MAKITA CORPORATION, Anjo-shi (JP)

(21) Appl. No.: 18/907,993

(22) Filed: Oct. 7, 2024

(30) Foreign Application Priority Data
Oct. 11, 2023 (JP) 2023-176311

(51) Int. Cl. B27B 17/10; F01P 7/04

(52) U.S. Cl. CPC B27B 17/10; F01P 7/046

(57) ABSTRACT

A working machine may include a prime mover including an output shaft, a working part coupled to the output shaft, a slip mechanism, and a fan attached to the output shaft via the slip mechanism. The slip mechanism may be configured to: in a case where a load torque applied on the output shaft when driving the fan is less than a predetermined value, rotate the output shaft and the fan integrally with each other, and in a case where the load torque when driving the fan is greater than or equal to the predetermined value, rotate the output shaft and the fan relative to each other.

### REFERENCE TO RELATED APPLICATIONS

This application claims priority from Japanese Patent Application No. 2023-176311 filed on Oct. 11, 2023. The entire content of the priority application is incorporated herein by reference.

### BACKGROUND ART

JP 2002-210705 A describes a working machine with a prime mover including an output shaft, a working part coupled to the output shaft, and a fan coupled to the output shaft.

### SUMMARY

In the working machine of JP 2002-210705 A, the working part and the fan are driven in response to the prime mover being driven. Depending on a situation in which the working machine is used, torque required to drive the fan may be greater than torque required to drive the fan in a situation in which the working machine is used in air (hereinafter referred to as “normal state of use”). In such a case, torque transmitted from the prime mover to the working part via the output shaft could become smaller than torque transmitted therebetween under the normal state of use.

This specification provides a technique that can suppress the reduction of torque transmitted from a prime mover to a working part via an output shaft in a working machine.

A working machine disclosed herein may comprise: a prime mover including an output shaft; a working part coupled to the output shaft; a slip mechanism; and a fan attached to the output shaft via the slip mechanism. The slip mechanism may be configured to: in a case where a load torque applied on the output shaft when driving the fan is less than a predetermined value, rotate the output shaft and the fan integrally with each other; and in a case where the load torque when driving the fan is greater than or equal to the predetermined value, rotate the output shaft and the fan relative to each other.

Under the normal state of use, the load torque is less than the predetermined value. On the other hand, in situations different from the normal state of use, the load torque may be at the predetermined value or more. According to the above configuration, the slip mechanism rotates the output shaft and the fan integrally with each other when the load torque in driving the fan is less than the predetermined value. This is because in the case where the load torque is less than the predetermined value, static friction torque generated by the slip mechanism is greater than the load torque. On the other hand, the slip mechanism rotates the output shaft and the fan relative to each other in the case where the load torque in driving the fan is equal to or greater than the predetermined value. That is, the fan is caused to slip against the output shaft. This is because in the case where the load torque is equal to or greater than the predetermined value, the static friction torque generated by the slip mechanism is smaller than the load torque. When the output shaft and the fan are rotating relative to each other, the torque required to drive the fan is smaller among the torque of the output shaft. Therefore, the torque transmitted from the prime mover to the working part via the output shaft can be suppressed from being reduced.

### BRIEF DESCRIPTION OF DRAWINGS

FIG. 1 is a perspective view seeing a chainsaw 2 of an embodiment from a rear left upper side.

FIG. 2 shows a left side view seeing the chainsaw 2 of the embodiment from the left.

FIG. 3 is a perspective view seeing the chainsaw 2 of the embodiment from a rear right upper side.

FIG. 4 shows a cross-sectional view seeing the chainsaw 2 of the embodiment from the right.

FIG. 5 shows a cross-sectional view seeing the chainsaw 2 of the embodiment from the front.

FIG. 6 is a perspective view seeing an inner housing 66 of the embodiment from the rear left upper side.

FIG. 7 is a perspective view seeing a fan 70 of the embodiment from a front right lower side.

FIG. 8 is an enlarged cross-sectional view of FIG. 5.

FIG. 9 shows a cross-sectional view of the chainsaw 2 used in air as seen from the right.

FIG. 10 shows a cross-sectional view of the chainsaw 2 used in water as seen from the right.

### DETAILED DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved working machines, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a working machine may comprise: a prime mover including an output shaft; a working part coupled to the output shaft; a slip mechanism; and a fan attached to the output shaft via the slip mechanism. The slip mechanism may be configured to: in a case where a load torque applied on the output shaft when driving the fan is less than a predetermined value, rotate the output shaft and the fan integrally with each other; and in a case where the load torque when driving the fan is greater than or equal to the predetermined value, rotate the output shaft and the fan relative to each other.

In one or more embodiments, when the fan is driven under a state where at least a part of the fan is immersed in water, the load torque may become greater than or equal to the predetermined value, and when the fan is driven under a state where an entirety of the fan is not immersed in water, the load torque may become less than the predetermined value.

In general, resistance of water on the fan when it is driven underwater is greater than resistance of air on the fan when it is driven in air. Therefore, the resistance on the fan when the fan is driven with at least a part of the fan immersed in water is greater than the resistance on the fan when the fan is driven with the entirety of the fan not immersed in water. As a result, the load torque when at least a part of the fan is immersed in water is greater than the load torque when the entirety of the fan is not immersed in water, which is greater than the predetermined value. According to the above configuration, the slip mechanism rotates the output shaft and the fan relative to each other when at least a part of the fan is immersed in water. Therefore, the torque transmitted from the prime mover to the working part via the output shaft can be reduced in the state where at least a part of the fan is immersed in water.

In one or more embodiments, the slip mechanism may comprise a biasing member extending along an axial direction of the output shaft. One end of the biasing member may be coupled to one of the output shaft and the fan, and another end of the biasing member may be in contact with another of the fan and the output shaft.

According to the above configuration, static friction torque generated by biasing force can be adjusted by adjusting the biasing force of the biasing member. In other words, the predetermined value can be adjusted by adjusting the force of the biasing member. Thus, the working machine can be adapted to various situations.

In one or more embodiments, the slip mechanism may further comprise a washer disposed between the other end of the biasing member and the fan in the axial direction. The other end of the biasing member may be in contact with the other of the fan and the output shaft via the washer.

According to the above configuration, the washer contacts the fan instead of the biasing member contacting the fan. In such a case of a configuration in which the biasing member contacts the fan, a portion of the fan that the biasing member contacts may wear out. By having the washer in contact with the fan instead of the biasing member, a contact area of the part in contact with the fan can be increased, and thus the fan can be suppressed from being worn out.

In one or more embodiments, the fan may comprise: a fan body constituted of resin and having an opening through which the output shaft passes; and a bush constituted of metal and disposed at the opening. The output shaft may be constituted of metal. A clearance may be defined between the bush and the output shaft in a direction perpendicular to the axial direction of the output shaft. A least one of an inner circumferential surface of the bush and a part of the output shaft that faces the inner circumferential surface may be surface treated.

When the working machine is used in water, a bush constituted of metal and an output shaft constituted of metal may corrode. When the bush and output shaft corrode, corrosion byproducts are produced. These corrosion byproducts may result in occupying the clearance between the bush and the output shaft. In this case, the output shaft and the fan would rotate integrally with each other regardless of whether or not the load torque upon driving the fan is equal to or greater than the predetermined value. According to the above configuration, it is possible to suppress corrosion of at least one of the bush and the part of the output shaft that faces the inner surface, and the output shaft and fan can be rotated relative to each other when the load torque in driving the fan is equal to or greater than the predetermined value.

In one or more embodiments, the fan may comprise: a fan body constituted of resin and including an opening through which the output shaft passes; and a bush constituted of metal and disposed at the opening. The slip mechanism may comprise a biasing member extending along an axial direction of the output shaft. One end of the biasing member may be coupled to the output shaft, and another end of the biasing member may be in contact with the bush of the fan.

The part of the fan that is in contact with the biasing member of the slip mechanism may wear out. The metal bush is more resistant to wear than a fan body constituted of resin. As such, the part of the fan that is in contact with the biasing member of the slip mechanism can be suppressed from wearing out, and durability of the fan can be improved.

In one or more embodiments, the prime mover may be a motor.

When the prime mover is a motor and the load torque of the motor is excessive, an excessively large current (hereinafter described as “overcurrent”) would flow in the motor. According to the above configuration, it is possible to suppress the overcurrent from flowing in the motor. Thus, the motor can be protected.

### Embodiment

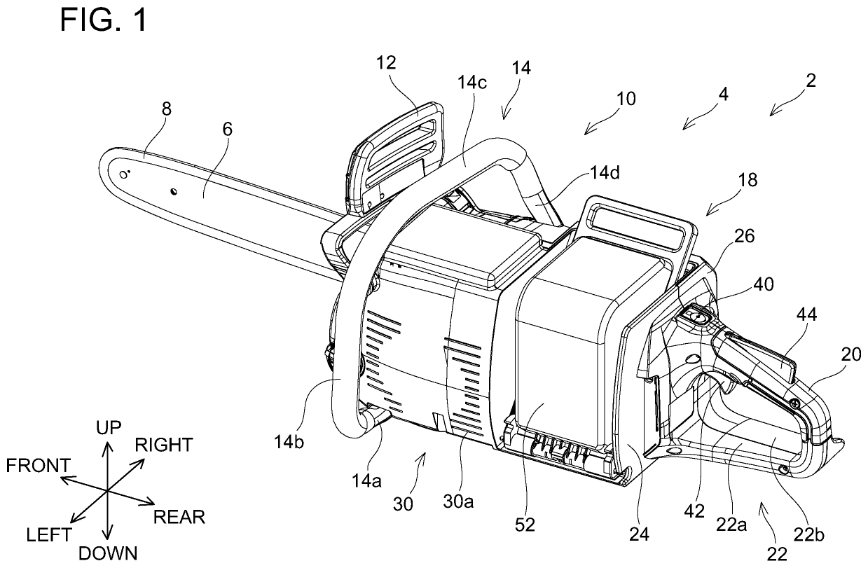

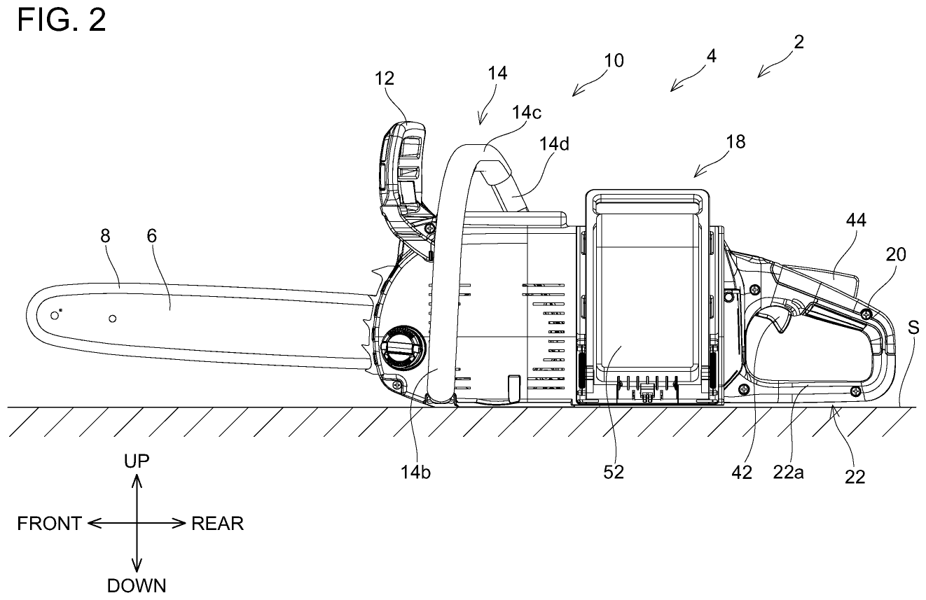

As shown in FIG. 1, a chainsaw 2 comprises a main body 4, a guide bar 6, and a saw chain 8. The guide bar 6 is an elongated plate-shaped member attached to the main body 4 so that it protrudes frontward from the main body 4. The guide bar 6 is constituted of a metallic material, such as iron, for example. The saw chain 8 has a plurality of interconnected cutters, and is attached along a periphery of the guide bar 6. In the following description, as shown in FIG. 2, when the chainsaw 2 is placed on a horizontal mounting surface S such as the ground, a direction orthogonal to the mounting surface S is referred to as an up-down direction of the chainsaw 2, a direction in which a longitudinal direction of the guide bar 6 is projected onto the mounting surface S is referred to as a front-back direction of the chainsaw 2, and a direction orthogonal to the up-down direction and also to the front-back direction of the chainsaw 2 is called a left-right direction of the chainsaw 2.

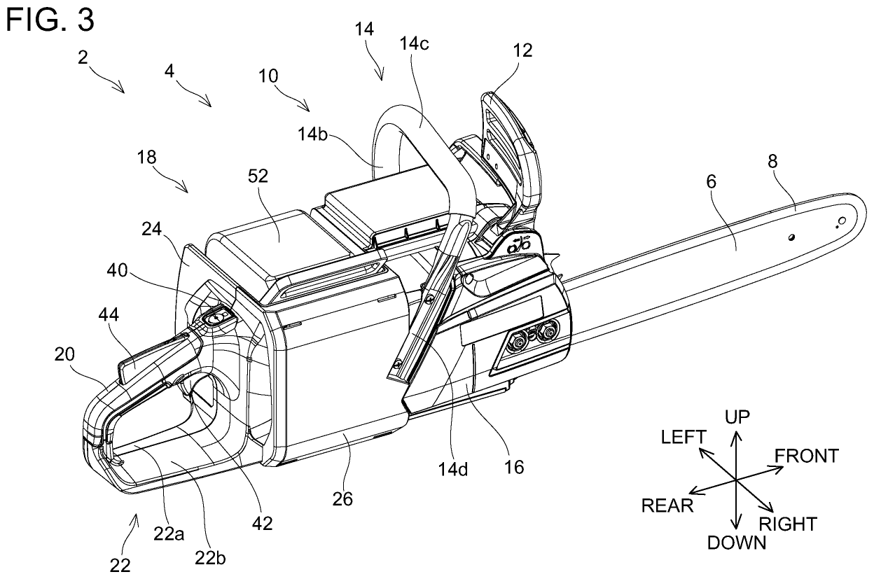

The main body 4 comprises a body housing 10, a front hand guard 12, a front handle 14, a sprocket cover 16 (see FIG. 3), a battery accommodating part 18, a rear handle 20, and a rear hand guard 22. As shown in FIG. 1, the body housing 10 is configured of a left side housing 24 and a right side housing 26. The body housing 10 has a substantially rectangular shape having a longitudinal direction in the front-back direction of the main body 4.

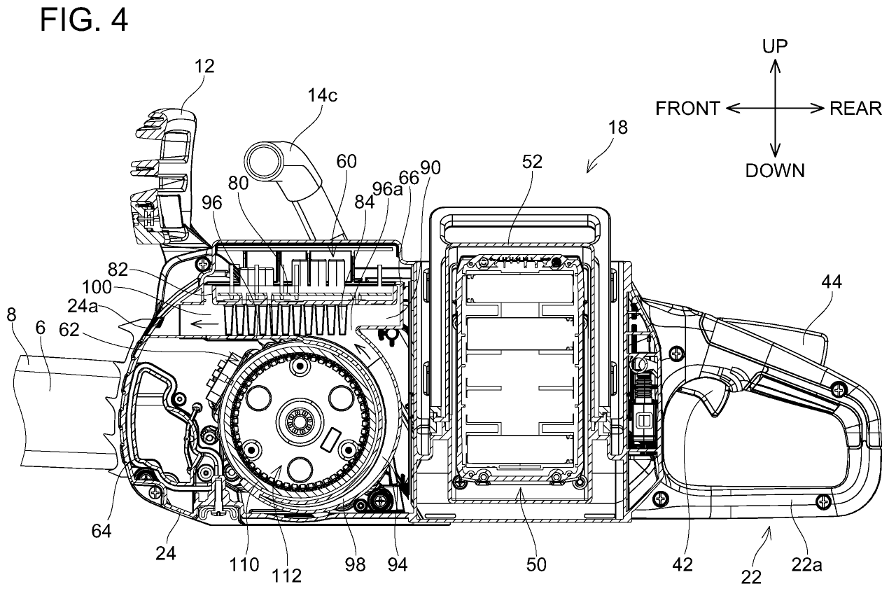

A left side of the left side housing 24 has an intake portion 30 with a plurality of intake openings 30a. As shown in FIG. 4, an exhaust opening 24a is defined in a front upper portion of the left side housing 24.

The front handle 14 in FIG. 1 is screw-fastened to a lower surface of the left side housing 24, and has a left side fixed portion 14a extending leftward from the lower surface of the left side housing 24, a left side gripping portion 14b extending upward from a left end of the left side fixed portion 14a, an upper gripping portion 14c extending rightward from an upper end of the left side gripping portion 14b, and a right side fixed portion 14d extending down-and-rearward from a right end of the upper gripping portion 14c. As shown in FIG. 3, the right side fixed portion 14d is screw-fastened to the right side housing 26 at a portion that is rearward of the sprocket cover 16. The front hand guard 12 is pivotably supported at a front upper portion of the body housing 10. The front hand guard 12 is located forward of the front handle 14. The front hand guard 12 protects a hand of a user grasping the upper gripping portion 14c of the front handle 14.

The rear handle 20 extends down-and-rearward from an upper part of a rear surface of the body housing 10, and is bent downward. The rear hand guard 22 extends rearward from a lower part of the rear surface of the body housing 10 and is connected to a lower end of the rear handle 20. The rear hand guard 22 comprises a first guard portion 22a located directly below the rear handle 20 and a second guard portion 22b extending rightward from the first guard portion 22a. The rear hand guard 22 protects a hand of the user grasping the rear handle 20.

A power button 40 configured to allow the user to switch the power of the chainsaw 2 on and off is located on an upper surface of the rear handle 20 near its front end. A trigger lever 42 is disposed on a lower surface of the rear handle 20 near its front end for the user to operate rotary drive of the saw chain 8. A lock lever 44 configured to switch between a state permitting the user to operate the trigger lever 42 and a state prohibiting to do so is disposed on the upper surface of the rear handle 20. The lock lever 44 is located rearward of the power button 40. When using the chainsaw 2, the user grasps the rear handle 20 with the right hand and the front handle 14 with the left hand to hold the chainsaw 2. From this state, the user pushes down the lock lever 44 of the rear handle 20 with a palm of the right hand, and operation of the trigger lever 42 by the user is permitted. In this state, when the user pulls up the trigger lever 42 with the index finger of the right hand, the saw chain 8 is driven to rotate.

The battery accommodating part 18 is located between the front handle 14 and the rear handle 20. The battery accommodating part 18 houses the battery 50 (see FIG. 4). The battery accommodating part 18 has a battery cover 52 configured to open and be closed.

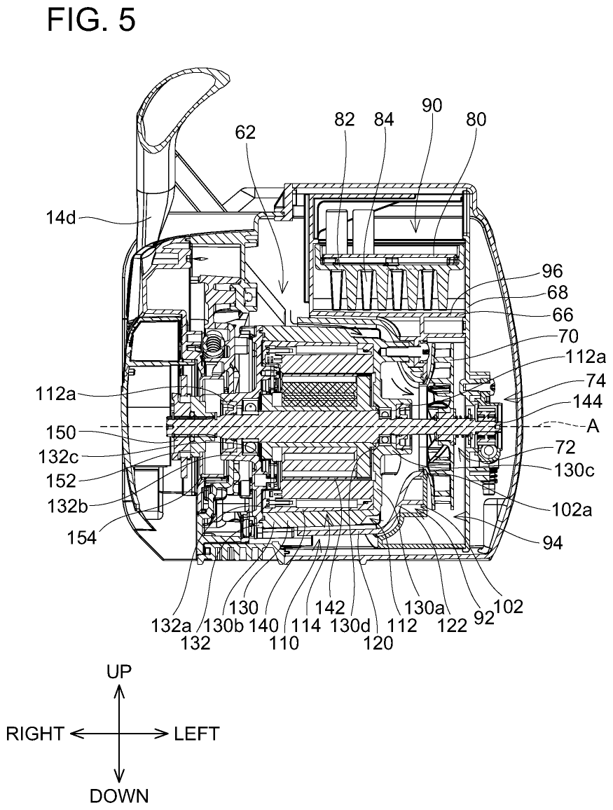

As shown in FIG. 4, a control unit 60, a motor unit 62, an oil tank 64, an inner housing 66, an inner housing cover 68 (see FIG. 5), a fan 70 (see FIG. 5), a slip mechanism 72 (see FIG. 5) and an oil pump 74 (see FIG. 5) are disposed at the front side within the body housing 10. The control unit 60 is located above the motor unit 62. The control unit 60 comprises a control board 80 and a board support portion 82 that supports the control board 80. The board support portion 82 includes a plurality of fins 84 protruding downward. The oil tank 64 is located at a lower front part of the body housing 10. The oil tank 64 stores lubricating oil for lubricating the saw chain 8.

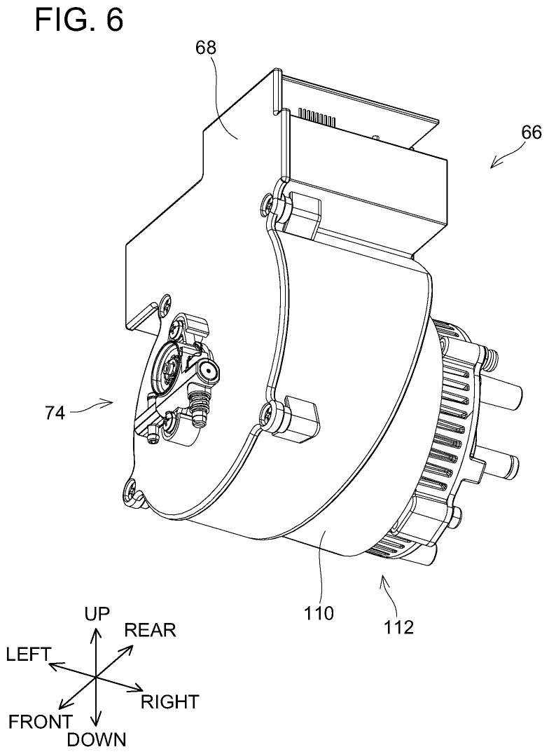

As shown in FIG. 5, the inner housing 66 comprises a control unit accommodating portion 90 that houses the control unit 60, a motor unit mounting portion 92, and a fan accommodating portion 94 that houses the fan 70. In the up-down direction, a first boundary wall 96 is disposed between the control unit accommodating portion 90 and the motor unit mounting portion 92 as well as the fan accommodating portion 94. As shown in FIG. 4, a first opening 96a is defined at a rear part of the first boundary wall 96 that connects the control unit accommodating portion 90 and the fan accommodating portion 94. The fan accommodating portion 94 has a first air flow path 98 through which air flows formed therein. The control unit accommodating portion 90 has a second air flow path 100 that connects the first air flow path 98 to the exhaust opening 24a of the left side housing 24 formed therein. As shown in FIG. 5, a second boundary wall 102 is disposed between the motor unit mounting portion 92 and the fan accommodating portion 94. A second opening 102a is defined at a center of the second boundary wall 102. As shown in FIG. 6, an inner housing cover 68 is attached to a left part of the inner housing 66. An outer shape of the inner housing cover 68 corresponds to an outer shape of the left part of the inner housing 66.

As shown in FIG. 5, the motor unit 62 comprises a motor case 110, a waterproof cover 112, and a motor 114. The motor case 110 is screwed and secured to a right side of the second boundary wall 102 of the inner housing 66. The motor case 110 comprises a case cylindrical portion 120 and a diameter-reducing portion 122 extending leftward from a left end of the case cylindrical portion 120. An axis of the case cylindrical portion 120 coincides with a central axis A of an output shaft 144 described below. An inner diameter of a left end of the diameter-reducing portion 122 is smaller than a diameter of the second opening 102a of the second boundary wall 102.

The waterproof cover 112 comprises a cover body 130 and a lid portion 132. The cover body 130 comprises a body-side disc portion 130a, a first cylindrical portion 130b having a cylindrical shape, and a second cylindrical portion 130c having a cylindrical shape. Axes of the body-side disc portion 130a, the first cylindrical portion 130b, and the second cylindrical portion 130c coincide with the central axis A of the output shaft 144 described below. A body-side opening 130d is defined at a center of the body-side disc portion 130a. The first cylindrical portion 130b extends rightward from an outer radial end of the body-side disc portion 130a. An outer diameter of the first cylindrical portion 130b is smaller than an inner diameter of the case cylindrical portion 120 of the motor case 110. Due to this, a clearance is defined between the first cylindrical portion 130b and the case cylindrical portion 120 of the motor case 110. The second cylindrical portion 130c extends leftward from the body-side disc portion 130a at a periphery of the body-side opening 130d. The lid portion 132 has a lid-side disc portion 132a and a third cylindrical portion 132b. A lid-side opening 132c is defined at a center of the lid-side disc portion 132a. The third cylindrical portion 132b extends leftward from the lid-side disc portion 132a at a periphery of the lid-side opening 132c. The lid portion 132 covers an opening at a right end of the cover body 130.

The motor 114 is waterproofed by the waterproof cover 112. The motor 114 is an inner rotor type DC brushless motor. In a variant, the motor 114 may be an outer rotor type brushless motor or a brushed motor. The motor 114 comprises a stator 140, a rotor 142 disposed inside the stator 140, and the output shaft 144 disposed so as to penetrate the centers of the stator 140 and the rotor 142 and fitted into the rotor 142. The output shaft 144 extends along the central axis A. The central axis A is parallel to the left-right direction. In the following, a direction along the central axis A is described as “axial direction”. A left end of the output shaft 144 is located to the left of a left end of the waterproof cover 112, and a right end of the output shaft 144 is located to the right of a right end of the waterproof cover 112. That is, the output shaft 144 passes through the waterproof cover 112 in the left-right direction. In the waterproof cover 112, a plurality of waterproof members 112a is arranged at locations through which the output shaft 144 penetrates.

A sprocket 150 and a brake base 152 are fixed to the right end of the output shaft 144. The saw chain 8 (see FIG. 1) is strapped onto the sprocket 150 from the guide bar 6. A brake drum 154 is fitted to the brake base 152. When the motor 114 is driven, the sprocket 150 rotates with the output shaft 144, which causes the saw chain 8 to rotate around the sprocket 150 and the guide bar 6.

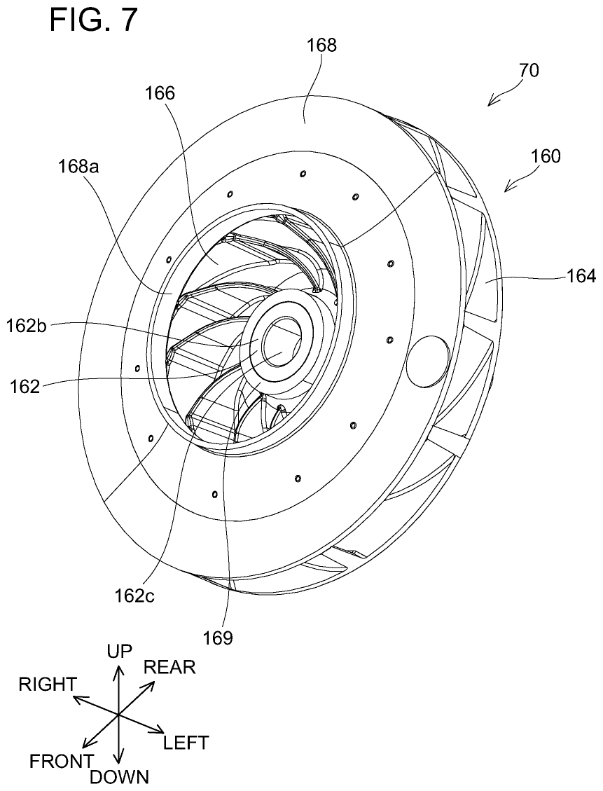

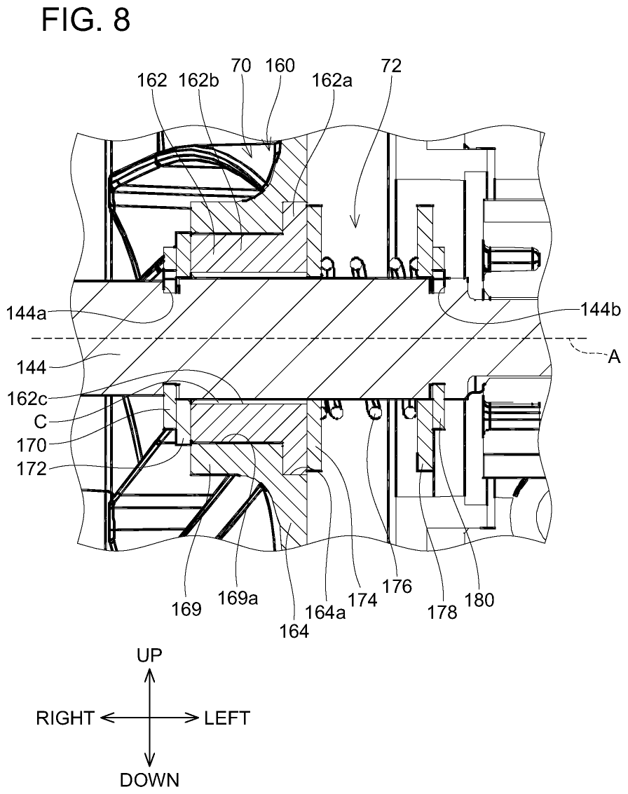

The fan 70, the slip mechanism 72, and the oil pump 74 are mounted on the left end of the output shaft 144. As shown in FIG. 7, the fan 70 comprises a fan body 160 constituted of resin, a bush 162 constituted of metal, and a rib 169. Although this is merely an example, the bush 162 is constituted of stainless steel. The fan body 160 comprises a fan disc portion 164, a plurality of vanes 166, and a cover portion 168. As shown in FIG. 8, a central opening 164a is defined at a center of the fan disc portion 164. The rib 169 is connected to the fan disc portion 164 and extends rightward from the fan disc portion 164 at the periphery of the central opening 164a. An inner diameter of the rib 169 is smaller than a diameter of the central opening 164a. An outer diameter of the rib 169 is smaller than an outer diameter of the fan disc portion 164.

The bush 162 is attached to inner circumferential surfaces of the central opening 164a and the rib 169. The bush 162 comprises a left side cylindrical portion 162a and a right side cylindrical portion 162b. The left side cylindrical portion 162a and the right side cylindrical portion 162b are attached to the inner circumferential surface of the central opening 164a and the inner circumferential surface 169a of the rib 169, respectively. An inner circumferential surface 162c of the bush 162 has an insulating surface treatment (e.g., a coating) to prevent corrosion when the bush 162 is exposed to water. A part of the output shaft 144 that faces the inner circumferential surface 162c also has an insulating surface treatment applied thereon. An inner diameter of the bush 162 is slightly larger than an outer diameter of the part of the output shaft 144 which the bush 162 faces. That is, a clearance C is defined between the bush 162 and the output shaft 144.

As shown in FIG. 7, the fan disc portion 164 and the plurality of vanes 166 are integrally molded. The plurality of vanes 166 extends rightward from the fan disc portion 164. The plurality of vanes 166 is curved along a counterclockwise direction as the vanes 166 extend radially from an inner side toward an outer side when the fan 70 is viewed from the right. The cover portion 168 is welded to right-side ends of the plurality of vanes 166. A fan-side intake opening 168a is defined at a center of the cover portion 168. A diameter of the fan-side intake opening 168a is larger than the outer diameter of the rib 169.

As shown in FIG. 8, in the output shaft 144, a first groove 144a is formed circumferentially on the right side of the bush 162, and a second groove 144b is formed on the left side of the bush 162. A right side E-ring 170 is fitted into the first groove 144a. A right side washer 172 is disposed between the right side E-ring 170 and the bush 162. The right side washer 172 is in contact with the right side E-ring 170 and the bush 162.

The slip mechanism 72 is located on the left side of the fan 70. The slip mechanism 72 comprises a central washer 174, a coil spring 176, a left side washer 178, and a left side E-ring 180. The left side E-ring 180 is fitted into the second groove 144b of the output shaft 144. The central washer 174 is positioned so that its right side is in contact with the bush 162. The left side washer 178 is positioned so that its left side is in contact with the left side E-ring 180. The coil spring 176 is positioned between the central washer 174 and the left side washer 178. Biasing force of the coil spring 176 pushes the central washer 174 against the bush 162. The biasing force of the coil spring 176 is adjusted such that the fan 70 and the output shaft 144 are to rotate integrally with each other in a case where torque applied to the output shaft 144 when driving the fan 70 (hereinafter described as “load torque”) is less than a predetermined value, and the fan 70 and the output shaft 144 are to rotate relative to each other in a case where the load torque when driving the fan 70 is greater than or equal to the predetermined value.

The state in which the load torque when driving the fan 70 is less than the predetermined value is a state in which static friction torque generated by the slip mechanism 72 is greater than the load torque. In this case, the fan 70 and the output shaft 144 rotate integrally with each other in response to the coupling between the fan 70 and the output shaft 144 via the slip mechanism 72. Further, the state in which the fan 70 and the output shaft 144 rotate integrally with each other is a state in which rotational speed of the fan 70 and rotational speed of the output shaft 144 are substantially the same.

The state in which the load torque when driving the fan 70 is greater than or equal to the predetermined value is a state in which the load torque exceeds the static friction torque generated by the slip mechanism 72. In this case, the fan 70 and the output shaft 144 rotate relative to each other in response to the fan 70 slipping against the output shaft 144 via the slip mechanism 72. Specifically, the fan 70 is rotated by dynamic frictional torque generated by the slip mechanism 72. The state in which the fan 70 and the output shaft 144 rotate relative to each other is a state in which the rotation speed of the fan 70 is less than the rotation speed of the output shaft 144.

### (Operation of Chainsaw 2 in Air)

An operation of the chainsaw 2 when it is used in air is then described.

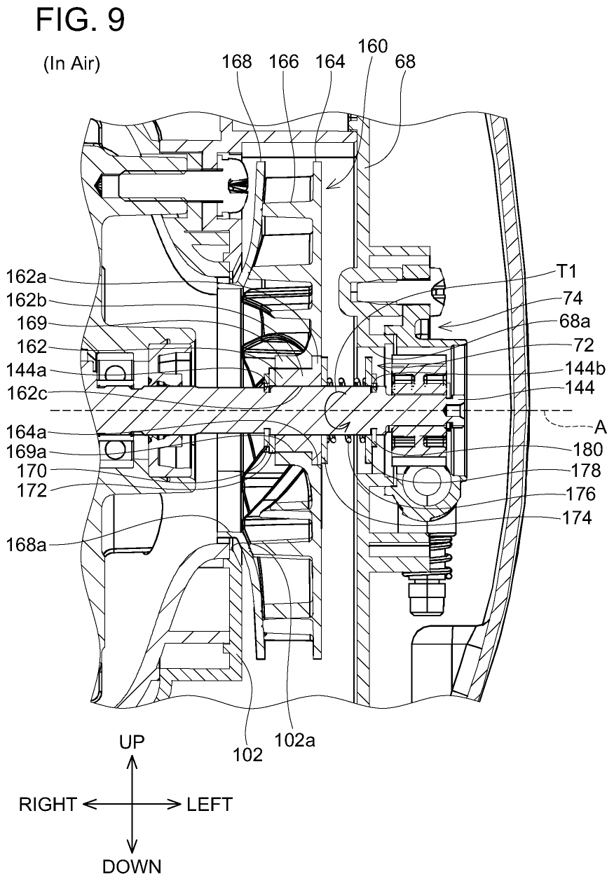

When the lock lever 44 of the rear handle 20 in FIG. 1 is pushed down and the trigger lever 42 is pulled up by the user, the motor 114 in FIG. 5 starts driving and the output shaft 144 rotates. This causes the sprocket 150 coupled to the output shaft 144 of the motor 114 to rotate. As shown in FIG. 9, when the chainsaw 2 is used in the air, the load torque is T1, which is less than the predetermined value. This is because an air resistance on the fan 70 when the fan 70 is driven is small. In this case, the fan 70 is coupled to the output shaft 144 via the slip mechanism 72, and the output shaft 144 and the fan 70 rotate integrally with each other. That is, the output shaft 144 and the fan 70 rotate integrally in response to the motor 114 being driven.

When the fan 70 is driven, the air from outside the body housing 10 is suctioned into the body housing 10 through the intake opening 30a (see FIG. 1) of the left side housing 24. The air entering the body housing 10 flows around the inner housing 66 (see FIG. 6) and then, as shown in FIG. 5, passes leftward between the waterproof cover 112 and the motor case 110. As the air passes between the waterproof cover 112 and the motor case 110, the motor 114 is cooled. Furthermore, the air passes through the second opening 102a of the second boundary wall 102 and is suctioned into the fan 70. As described above, the shape of the plurality of vanes 166 of the fan 70 is curved along the counterclockwise direction as it extends radially from the inner side toward the outer side (see FIG. 7). As a result, the air suctioned into the fan 70 is pushed radially outward and flows into the first air flow path 98 (see FIG. 4). The air flowing into the first air flow path 98 then passes through the first opening 96a and the second air flow path 100, as shown in FIG. 4. As the air passes through the second air flow path 100, the control board 80 is cooled. The air in the second air flow path 100 is then exhausted from the exhaust opening 24a of the left side housing 24 to the outside.

### (Operation of Chainsaw 2 in Water)

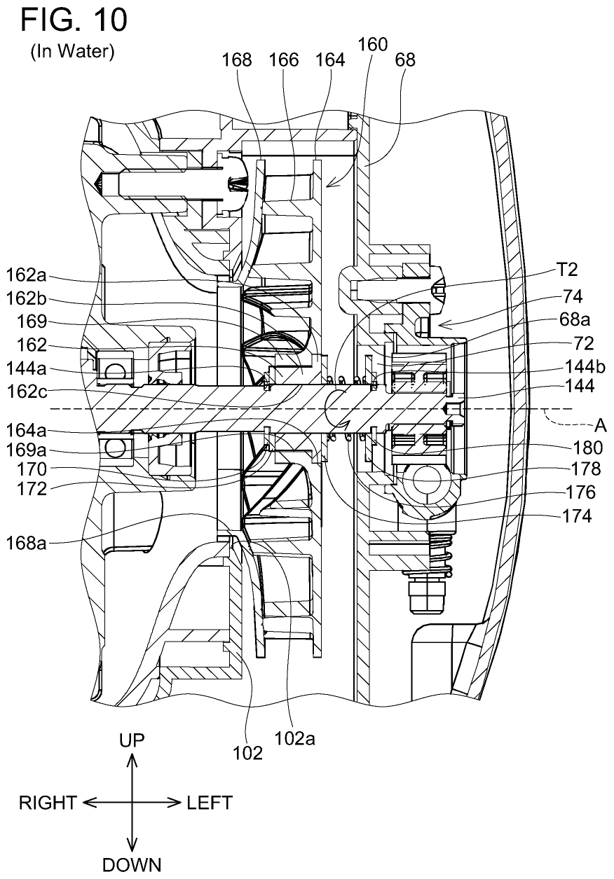

An operation of the chainsaw 2 when the chainsaw 2 is used in water will be described. When the user executes the same operation as when the chainsaw 2 is used in the air, the motor 114 in FIG. 5 starts driving and the output shaft 144 thereby rotates. As shown in FIG. 10, when the chainsaw 2 is used in water, the load torque is T2, which is greater than the predetermined value. This is because the resistance of water on the fan 70 when the fan 70 is driven underwater is greater than the resistance of air on the fan 70 when the fan 70 is driven in air. In this case, the resistance of the water on the fan 70 exceeds the biasing force of the coil spring 176, causing the central washer 174 of the slip mechanism 72 and the bush 162 of the fan 70 to slip. Due to this, the rotational speed of the fan 70 becomes less than the rotational speed of the output shaft 144, and the output shaft 144 and the fan 70 rotate relative to each other. Specifically, the rotational speed of the fan 70 becomes less than the rotational speed of the output shaft 144.

As above, in the chainsaw 2 of the present embodiment, the output shaft 144 and the fan 70 rotate integrally with each other when the chainsaw 2 is used in the air, and the output shaft 144 and the fan 70 rotate relative to each other when the chainsaw 2 is used in water.

In one or more embodiments, the chainsaw 2 (an example of “working machine”) comprises: the motor 114 (an example of “prime mover”) including the output shaft 144; the saw chain 8 (an example of “working part”) coupled to the output shaft 144; the slip mechanism 72; and the fan 70 attached to the output shaft 144 via the slip mechanism 72. The slip mechanism 72 is configured to: in the case where the load torque in driving the fan 70 is less than the predetermined value, rotate the output shaft 144 and the fan 70 integrally with each other, and in the case where the load torque in driving the fan 70 is equal to or greater than the predetermined value, rotate the output shaft 144 and the fan 70 relative to each other.

When the chainsaw 2 is used in air, the load torque is less than the predetermined value. On the other hand, when the chainsaw 2 is used in water, the load torque is equal to or greater than the predetermined value. According to the above configuration, the slip mechanism 72 rotates the output shaft 144 and the fan 70 integrally with each other in the case where the load torque in driving the fan 70 is less than the predetermined value. This is because in the case where the load torque is less than the predetermined value, the static friction torque generated by the slip mechanism 72 is greater than the load torque. On the other hand, the slip mechanism 72 rotates the output shaft 144 and the fan 70 relative to the output shaft 144 in the case where the load torque in driving the fan 70 is equal to or greater than the predetermined value. That is, the fan 70 is caused to slip against the output shaft 144. This is because in the case where the load torque is equal to or greater than the predetermined value, the static friction torque generated by the slip mechanism 72 is smaller than the load torque. In the case where the output shaft 144 and the fan 70 are rotating relative to each other, the torque required to drive the fan 70 among the torque of the output shaft 144 is smaller. Therefore, the torque transmitted from the motor 114 to the saw chain 8 via the output shaft 144 can be suppressed from being reduced.

In one or more embodiments, when at least a part of the fan 70 is immersed in water, the load torque becomes greater than or equal to the predetermined value, whereas on the other hand, when the entirety of the fan 70 is not immersed in water, the load torque becomes less than the predetermined value.

Generally, the resistance of water on the fan 70 when the fan 70 is driven underwater is greater than the resistance of air on the fan 70 when the fan 70 is driven in air. Therefore, the resistance on the fan 70 when the fan 70 is driven with at least a part of the fan 70 immersed in water is greater than the resistance on the fan 70 when the fan 70 is driven with the entirety of the fan 70 not immersed in water. As a result, the load torque when at least a part of the fan 70 is immersed in water is greater than the load torque when the entirety of the fan 70 is not immersed in water, and it is greater than the predetermined value. According to the above configuration, the slip mechanism 72 rotates the output shaft 144 and the fan 70 relative to each other when at least a part of the fan 70 is immersed in water. Therefore, the torque transmitted from the motor 114 to the saw chain 8 via the output shaft 144 can be suppressed from being reduced in the state where at least a part of the fan 70 is immersed in water.

In one or more embodiments, the slip mechanism 72 comprises the coil spring 176 (an example of “biasing member”) extending along the axial direction of the output shaft 144, wherein the left end (an example of “one end”) of the coil spring 176 is coupled to the output shaft 144 and the right end (an example of “another end”) of the coil spring 176 is in contact with the fan 70.

According to the above configuration, the static friction torque generated by the biasing force can be adjusted by adjusting the biasing force of the coil spring 176. In other words, the predetermined value can be adjusted by adjusting the biasing force of the coil spring 176. Thus, the chainsaw 2 can be adapted to various situations.

In one or more embodiments, the slip mechanism 72 further comprises the central washer 174 (an example of “washer”) disposed between the right end of the coil spring 176 and the fan 70 in the axial direction. The right end of the coil spring 176 is in contact with the fan 70 via the central washer 174.

According to the above configuration, the central washer 174 contacts the fan 70 instead of the coil spring 176 contacting the fan 70. The part of the slip mechanism 72 that is in contact with the fan 70 could wear out. By having the central washer 174 in contact with the fan 70 instead of the coil spring 176, the contact area of the part in contact with the fan 70 can be increased, thus the fan 70 can be suppressed from being worn out.

In one or more embodiments, the fan 70 comprises: the fan body 160 constituted of resin and having the central opening 164a and the rib 169 (examples of “opening”) through which the output shaft 144 passes; and the bush 162 constituted of metal and disposed at the central opening 164a and the rib 169. The output shaft 144 is constituted of metal. The clearance C is defined between the bush 162 and the output shaft 144 in the direction perpendicular to the axial direction. The inner circumferential surface 162c of the bush 162 and the part of the output shaft 144 that faces the inner circumferential surface 162c are surface treated.

When the chainsaw 2 is used in water, the bush 162 constituted of metal and the output shaft 144 constituted of metal may corrode. When the bush 162 and output shaft 144 corrode, corrosion byproducts are produced. These corrosion byproducts may result in occupying the clearance C between the bush 162 and the output shaft 144. In this case, the output shaft 144 and the fan 70 rotate integrally with each other regardless of whether the load torque in driving the fan 70 is equal to or greater than the predetermined value or not. According to the above configuration, it is possible to suppress corrosion of at least one of the bush 162 and the output shaft 144, and the output shaft 144 and the fan 70 can be rotated relative to each other in the case where the load torque in driving the fan 70 is equal to or greater than the predetermined value.

In one or more embodiments, the fan 70 comprises the fan body 160 constituted of resin and including the central opening 164a and the rib 169 through which the output shaft 144 passes, and the metal bush 162 disposed at the central opening 164a and the rib 169. The slip mechanism 72 comprises the coil spring 176 extending along the axial direction, wherein the left end of the coil spring 176 is coupled to the output shaft 144 and the right end of the coil spring 176 is in contact with the bush 162 of the fan 70.

The part of the fan 70 that is in contact with the coil spring 176 of the slip mechanism 72 may wear out. The metal bush 162 is more resistant to wear than the fan body 160 constituted of resin. As such, the part of the fan 70 that is in contact with the coil spring 176 of the slip mechanism 72 can be suppressed from wearing out, and the durability of the fan 70 can be improved.

In one or more embodiments, the chainsaw 2 comprises the motor 114 as its prime mover.

When the prime mover is the motor 114 and the load torque of the output shaft 144 of the motor 114 is excessive, an excessively large current (hereinafter described as “overcurrent”) would flow in the motor 114. According to the above configuration, it is possible to suppress the overcurrent from flowing in the motor 114. Thus, the motor 114 can be protected.
(First Variant) “Working machine” is not limited to chainsaw 2, but can be a lawnmower, mower, hedge trimmer, etc.
(Second Variant) The right end of the coil spring 176 of the slip mechanism 72 may be coupled to the fan 70 and the left end of the coil spring 176 of the slip mechanism 72 may be in contact with the output shaft 144. In this variant, the right and left ends of the coil spring 176 are examples of “one end” and “other end” of the “biasing member”, respectively.
(Third Variant) The slip mechanism 72 may comprise an elastic member such as a dish spring, rubber, etc., instead of the coil spring 176. In another variant, the slip mechanism 72 may not comprise the central washer 174.
(Fourth Variant) The fan 70 may not have the bush 162. In another variant, both of the inner circumferential surface 162c of the bush 162 and the part of the output shaft 144 that faces the inner circumferential surface 162c may not be surface treated. In a yet another variant, only one of the inner circumferential surface 162c of the bush 162 and the part of the output shaft 144 that faces the inner circumferential surface 162c may be surface treated.
(Fifth Variant) The slip mechanism 72 may be in contact with the fan body 160 of the fan 70, the fan body 160 is constituted of resin.
(Sixth Variant) “Prime mover” is not limited to the motor 114, but may be an engine.
(Seventh Variant) In the above chainsaw 2, the saw chain 8 is disposed on the right side of the motor 114 in the axial direction, and the slip mechanism 72 and the fan 70 are provided on the left side of the motor 114 in that order. In a variant, the saw chain 8, the fan 70, and the slip mechanism 72 may be disposed on the left or right side of motor 114 in the axial direction.

What is claimed is:

1. A working machine, comprising:
a prime mover including an output shaft;
a working part coupled to the output shaft;
a slip mechanism; and
a fan attached to the output shaft via the slip mechanism,
wherein the slip mechanism is configured to:
in a case where load torque applied on the output shaft when driving the fan is less than a predetermined value, rotate the output shaft and the fan integrally with each other; and
in a case where the load torque when driving the fan is greater than or equal to the predetermined value, rotate the output shaft and the fan relative to each other.

2. The working machine according to claim 1, wherein when the fan is driven under a state where at least a part of the fan is immersed in water, the load torque becomes greater than or equal to the predetermined value, and
when the fan is driven under a state where an entirety of the fan is not immersed in water, the load torque becomes less than the predetermined value.

3. The working machine according to claim 1, wherein the slip mechanism comprises a biasing member extending along an axial direction of the output shaft,
wherein one end of the biasing member is coupled to one of the output shaft and the fan, and
another end of the biasing member is in contact with another of the fan and the output shaft.

4. The working machine according to claim 3, wherein the slip mechanism further comprises a washer disposed between the other end of the biasing member and the fan in the axial direction,
wherein the other end of the biasing member is in contact with the other of the fan and the output shaft via the washer.

5. The working machine according to claim 1, wherein the fan comprises:
a fan body constituted of resin and having an opening through which the output shaft passes; and
a bush constituted of metal and disposed at the opening,
wherein the output shaft is constituted of metal,
wherein a clearance is defined between the bush and the output shaft in a direction perpendicular to the axial direction of the output shaft, and
at least one of an inner circumferential surface of the bush and a part of the output shaft that faces the inner circumferential surface is surface-treated.

6. The working machine according to claim 1, wherein the fan comprises:
a fan body constituted of resin and including an opening through which the output shaft passes; and
a bush constituted of metal and disposed at the opening,
wherein the slip mechanism comprises a biasing member extending along an axial direction of the output shaft,
wherein one end of the biasing member is coupled to the output shaft, and
another end of the biasing member is in contact with the bush of the fan.

7. The working machine according to claim 1, wherein the prime mover is a motor.

8. A working machine, comprising:
a prime mover including an output shaft;
a working part coupled to the output shaft;
a slip mechanism; and
a fan attached to the output shaft via the slip mechanism,
wherein the slip mechanism is configured to:
in a case where a load torque applied on the output shaft when driving the fan is less than a predetermined value, rotate the output shaft and the fan integrally with each other; and
in a case where the load torque when driving the fan is greater than or equal to the predetermined value, rotate the output shaft and the fan relative to each other,
wherein when the fan is driven under a state where at least a part of the fan is immersed in water, the load torque becomes greater than or equal to the predetermined value, and
when the fan is driven under a state where an entirety of the fan is not immersed in water, the load torque becomes less than the predetermined value,
wherein the slip mechanism comprises a biasing member extending along an axial direction of the output shaft,
wherein the fan comprises:
a fan body constituted of resin and having an opening through which the output shaft passes; and
a bush constituted of metal and disposed at the opening,
wherein the output shaft is constituted of metal,
wherein a clearance is defined between the bush and the output shaft in a direction perpendicular to the axial direction of the output shaft, and
at least one of an inner circumferential surface of the bush and a part of the output shaft that faces the inner circumferential surface is surface-treated,
wherein one end of the biasing member is coupled to the output shaft, and
another end of the biasing member is in contact with the bush of the fan,
wherein the slip mechanism further comprises a washer disposed between the other end of the biasing member and the fan in the axial direction,
wherein the other end of the biasing member is in contact with the other of the fan and the output shaft via the washer,
wherein the prime mover is a motor.
